(19) United States
(12) Patent Application Publication
(10) Pub. No.: US 2022/0212647 A1
(43) Pub. Date: Jul. 7, 2022

(54) ELECTROMECHANICALLY DRIVEABLE BRAKE PRESSURE GENERATOR FOR A HYDRAULIC BRAKING SYSTEM OF A VEHICLE, AND VEHICLE INCLUDING AN ELECTROMECHANICAL BRAKE PRESSURE GENERATOR

(71) Applicant: Robert Bosch GmbH, Stuttgart (DE)

(72) Inventors: Sebastian Martin Reichert, Affaltrach (DE); Claus Oehler, Karlsruhe (DE); Matthias Greiner, Simmozheim (DE)

(21) Appl. No.: 17/605,167

(22) PCT Filed: Feb. 18, 2020
(86) PCT No.: PCT/EP2020/054272

§ 371 Date: Oct. 20, 2021

(30) Foreign Application Priority Data
Apr. 25, 2019 (DE) 10 2019 205 958.9

(51) Int. Cl. B60T 13/74; B60T 17/08; B60T 17/16

(52) U.S. Cl. CPC B60T 13/745; B60T 17/16; B60T 17/08

(57) ABSTRACT

The invention relates to an electromechanical brake pressure generator (14) for a hydraulic braking system (10) of a vehicle. The electromechanical brake pressure generator (14) includes at least one threaded drive assembly (40) for converting a drive-side rotation into a translation for brake pressure generation. The threaded drive assembly (40) includes a spindle (68), which is rotatable via an electric motor (38), and a spindle nut (80), which is situated on a thread (76) of the spindle (68) in such a way that the spindle nut (80) and a hydraulic piston (92) formed thereon are axially displaceable upon rotation of the spindle (68). In addition, the threaded drive assembly (40) includes a housing (64), which forms a hydraulic cylinder (66) corresponding to the hydraulic piston (92), in which the spindle (68) and the spindle nut (80) are accommodated, and a rotation lock (84, 88), via which the spindle nut (80) is secured against rotation upon rotation of the spindle (68).

### FIELD

The present invention relates to an electromechanically driveable brake pressure generator for a hydraulic braking system of a vehicle and to a vehicle including an electromechanical brake pressure generator.

### BACKGROUND INFORMATION

The electromechanical brake pressure generator includes, in particular, a threaded drive assembly for converting a drive-side rotation into a translation for the hydraulic brake actuation.

The foot force of the driver mostly does not suffice for decelerating motor vehicles, and so motor vehicles are usually equipped with a brake booster. Conventional brake boosters generally operate at an underpressure generated by the internal combustion engine. The pressure difference between the engine pressure and the ambient pressure is utilized for applying a boosting force, in addition to the foot force of the driver, onto the piston rod of the piston/cylinder unit.

Alternative brake pressure build-up devices are required for future drive concepts of motor vehicles, since the underpressure is no longer available for operating a conventional vacuum brake booster. The electromechanical brake pressure generators of interest here were developed for this purpose.

The actuating force at the piston/cylinder unit is generated with the aid of an electric motor. Such electromechanical brake pressure generators may be utilized not only for providing an auxiliary power, but rather, in brake-by-wire systems, also for solely providing the actuating force. For this reason, electromechanical brake pressure generators are advantageous, in particular, with respect to autonomous driving.

PCT Patent Application No. WO 2017/045804 A1 describes a conventional electromechanical brake booster, which is represented in FIG. 1. In contrast thereto, the present invention is directed to an electromechanical brake pressure generator, which may apply a braking force regardless of an actuation of the brake pedal. The conventional brake booster 1 includes a spindle nut 2 and an electric motor (not outlined), via the operation of which spindle nut 2 is settable into a rotation via a spur gear 3.

Spindle nut 2 is operatively engaged with a spindle 4, and therefore spindle 4 is settable into a translation along its spindle axis 5 with the aid of the spindle nut 2, which has been set into rotation. In order to ensure that spindle 4 does not also rotate due to the rotation of spindle nut 2, brake booster 1 includes a bearing assembly 6, to which spindle 4 is fixedly connected.

Bearing assembly 6 includes a bracket 6a, at the edges of which two slide bearings 6b are situated. Slide bearings 6b run at tie rods 7, which extend essentially in parallel to spindle axis 5. Due to this bearing assembly 6, spindle 4 is movable in the axial direction and is secured against rotation.

An object of the present invention is to provide an improved electromechanical brake pressure generator, which is more cost-effectively manufacturable.

### SUMMARY

An object of the present invention may be achieved by an electromechanical brake pressure generator for a hydraulic braking system in accordance with an example embodiment of the present invention. Advantageous refinements and embodiments of the present invention are disclosed herein.

The present invention provides an electromechanical brake pressure generator for a hydraulic braking system of a vehicle. In accordance with an example embodiment of the present invention, this electromechanical brake pressure generator includes at least one threaded drive assembly for converting a drive-side rotation into a translation in order to generate brake pressure. The threaded drive assembly includes a spindle, which is rotatable via an electric motor, and a spindle nut, which is situated on a thread of the spindle in such a way that the spindle nut and a hydraulic piston formed thereon are axially displaceable upon rotation of the spindle.

In addition, the threaded drive assembly includes a housing, which forms a hydraulic cylinder corresponding to the hydraulic piston, in which the spindle and the spindle nut are accommodated, and a rotation lock formed with the housing, via which the spindle nut is secured against rotation upon rotation of the spindle.

A threaded drive assembly is understood to be a pure spindle drive, in which the spindle nut is in direct contact with the spindle, as well as a ball screw. A ball screw is a worm gear including balls inserted between the spindle and the spindle nut. Each of the two parts has a helical groove, which, together, form a helical tube filled with balls. The form-fitting connection in the thread transverse to the helix does not take place between the thread groove and dam, as is the case with a pure spindle drive, but rather via the balls.

The hydraulic piston rests directly against the brake fluid, so that the brake fluid may be acted upon by pressure via the hydraulic piston. Preferably, the hydraulic piston is designed in the shape of a cup. Preferably, a portion of the spindle engages into the cup-shaped recess.

The rotation lock may be formed, for example, by the spindle nut and the housing per se, as well as via an additional part.

In accordance with an example embodiment of the present invention, the rotation lock prevents the spindle nut from also rotating when the spindle rotates, so that the spindle nut is axially displaceable on the spindle by rotating the spindle. An advantage of the driven spindle is that the torque introduced into the spindle nut due to the rotation of the spindle may be more easily diverted. As a result, the spindle nut may be guided, for example, by a simple guidance in the housing. As a result, parts for a rotation lock of this type are saved, so that a rotation lock of this type is more economically and, thereby, more cost-effectively manufacturable. As a result, an improved electromechanical brake pressure generator may be provided, which, due to the reduced number of parts, requires less installation space and, thereby, is also more lightweight.

In one preferred embodiment of the present invention, the spindle nut and the hydraulic piston are made of different materials and are situated lying coaxially next to one another. Due to the formation from different materials, a material, which is optimal for the different function of the spindle nut and the hydraulic piston, may be selected. In this way, a material may be selected for the hydraulic piston, which has, for example, a greater strength. Correspondingly, a material may be selected for the spindle nut, which has, for example, good tribological properties.

In one further preferred embodiment of the present invention, the rotation lock is formed by the housing and the hydraulic piston and/or the spindle nut. The housing and the hydraulic piston and/or the spindle nut preferably interact via structural elements in such a way that a rotation of the spindle nut with respect to the housing is avoided. As a result, a rotation lock may be formed in an easy way.

Preferably, the rotation lock is formed via a tongue and groove connection. A tongue and groove connection is characterized, in particular, by a groove and a tongue accommodatable therein, which are exactly matched to each another. The groove and the tongue engage into each other in a form-fitted manner. The tongue and groove connection may be formed as a groove and a tongue, for example, at the components to be secured with respect to one another. It is also possible that an additional part, which is designed as a tongue, engages into grooves of the components to be secured.

The tongue and groove connection may be manufactured by stamping, broaching, or a machining operation. As a result, such tongue and groove connections are easily and economically manufacturable and ensure a good rotation lock.

In one advantageous refinement of the present invention, the rotation lock of the spindle nut forms two diametrically opposed, radially outwardly extending blades, which engage into corresponding grooves of the housing. The blades have an angle of 180° with respect to one another. Within the scope of the present invention, blades are understood to be elements protruding from the main body of the spindle nut. Due to blades situated in this way, the spindle nut may be sufficiently secured against rotation. Additionally, the spindle nut is centrally retained with little play.

Advantageously, at least one portion of the spindle nut is made of plastic. This portion may be attached at a main portion of the spindle nut. As a result, the costs and the weight of a spindle nut manufactured in such a way may be reduced.

In one further advantageous embodiment of the present invention, the portion of the spindle nut made of plastic is designed as a plastic injection-molded part. The portion of the spindle nut made of plastic may be injected onto a main portion of the spindle nut. As a result, a simple mounting of the plastic is possible, so that a spindle nut of this type is economically manufacturable. Additionally, as a result, the number of components is reduced.

Advantageously, the housing is made of an aluminum or steel alloy. Due to a housing of this type, a sufficient strength against the generated pressures may be ensured. These materials also have a good wear resistance. A good heat dissipation is also ensured. When an aluminum alloy is utilized, in addition, the weight may be reduced as compared to many other metals. In addition, an aluminum alloy has a particularly high heat conductance.

According to one further advantageous embodiment of the present invention, at least the rotation lock at the spindle nut and/or the hydraulic piston is made of plastic, in order to improve the slide properties with respect to the housing made of metal. As a result, the side of the rotation lock made of plastic slides on a metal surface of the housing. As a result, a wear-resistant and efficient pair of slide elements is ensured. This pair of slide elements enables an optimized design with respect to NVH (NVH: noise, vibration, harshness).

The present invention also relates to a vehicle including an electromechanical brake pressure generator for a hydraulic braking system, in accordance with an example embodiment of the present invention. With a vehicle of this type, the advantages mentioned with respect to the electromechanical brake pressure generator may be achieved. In one preferred embodiment, this vehicle may be an automated or fully autonomous vehicle.

Exemplary embodiments of the present invention are represented in the figures and are explained in greater detail in the description below.

### BRIEF DESCRIPTION OF THE DRAWINGS

FIG. 1 shows a representation of an electromechanical brake booster from the related art.

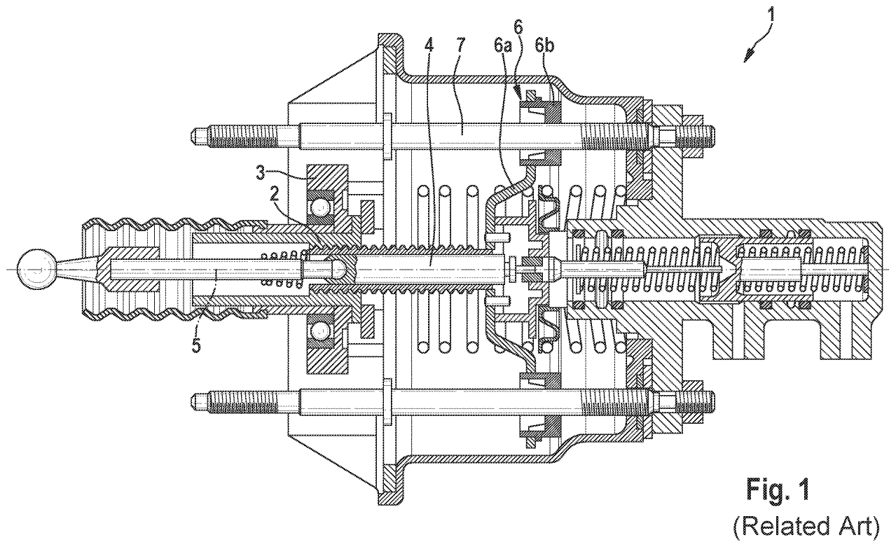

FIG. 2 shows a schematic representation of a hydraulic braking system for a vehicle including an electromechanical brake pressure generator.

FIG. 3 shows a cross-sectional and longitudinal section of an exemplary embodiment of a threaded drive assembly according to the present invention of the electromechanical brake pressure generator, in accordance with the present invention.

### DETAILED DESCRIPTION OF EXAMPLE EMBODIMENTS

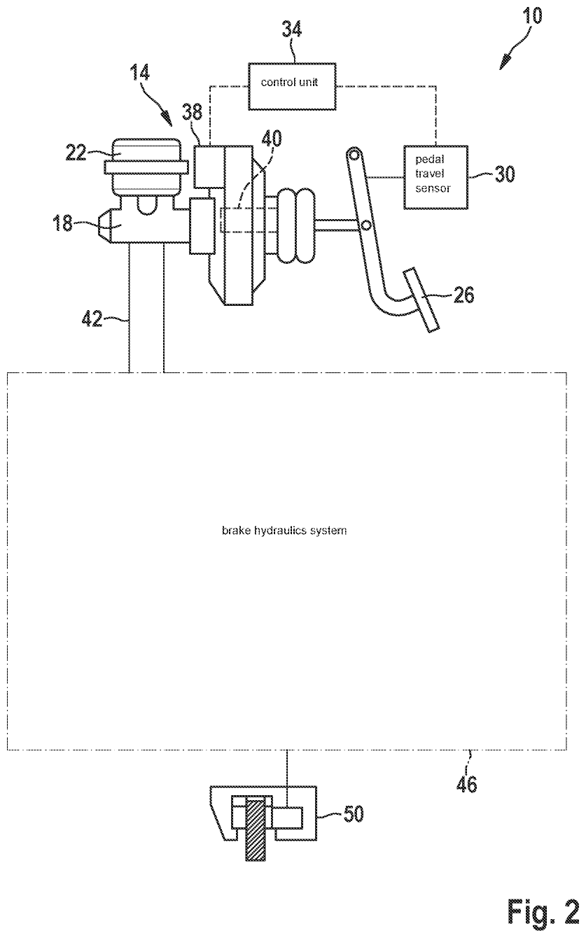

In FIG. 2, a schematic representation of a hydraulic braking system 10 for a vehicle including an electromechanical brake pressure generator 14 is shown. Hydraulic braking system 10 includes electromechanical brake pressure generator 14. This brake pressure generator 14 includes a piston/cylinder unit 18, which is supplied with brake fluid via a brake fluid reservoir 22.

Piston/cylinder unit 18 may be activated via a brake pedal 26 actuated by the driver and the resultant brake pedal travel is measured by a pedal travel sensor 30 and forwarded to a control unit 34.

Although FIG. 2 shows, in principle, a brake booster; here the brake pedal travel is measured via pedal travel sensor 30. A brake pressure generation without a brake pedal travel is also possible, so that the vehicle is deceleratable also in the autonomous driving condition.

Control unit 34 generates, on the basis of the measured brake pedal travel, a control signal for an electric motor 38 of brake pressure generator 14. Electric motor 38, which is connected to a transmission (not shown) of brake pressure generator 14, boosts the braking force introduced by brake pedal 26 according to the control signal. For this purpose, according to the actuation of brake pedal 26, a threaded drive assembly 40 situated in brake pressure generator 14 is activated by electric motor 38, so that the rotation of electric motor 38 is converted into a translation.

Due to the actuation of brake pedal 26, the brake fluid present in piston/cylinder unit 18 is pressurized with the aid of brake pressure generator 14. This brake pressure is forwarded to a brake hydraulics system 46 via brake lines 42. Brake hydraulics system 46, which is represented here only as a box, is formed by various valves and further components for forming, for example, an electronic stability program (ESP). Brake hydraulics system 46 is additionally connected to at least one wheel brake unit 50, so that a braking force is able to be applied at wheel brake unit 50 due to an appropriate switching of valves.

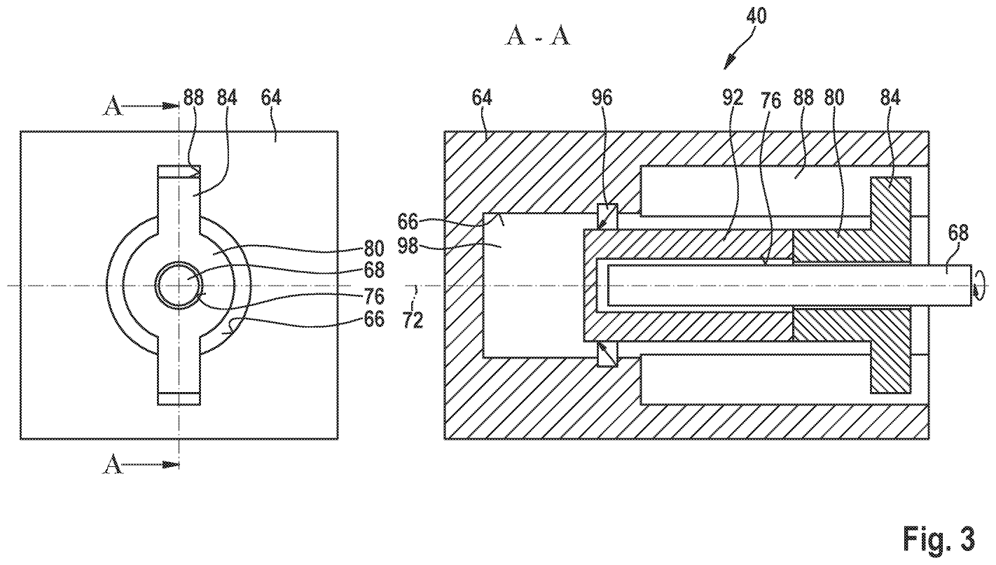

FIG. 3 shows a cross-sectional and longitudinal section of one exemplary embodiment of threaded drive assembly 40 according to the present invention of electromechanical brake pressure generator 14. Threaded drive assembly 40 includes a housing 64, which forms a cup-shaped hydraulic cylinder 66. In this exemplary embodiment, housing 64 is made of metal. Additionally, threaded drive assembly 40 includes a spindle 68, which is drivable via electric motor 38 shown in FIG. 2, so that spindle 68 carries out a rotary motion about its longitudinal axis 72.

A spindle nut 80 is situated on a thread 76 of spindle 68 and is engaged with thread 76 of spindle 68. Spindle nut 80 essentially forms a hollow cylindrical body. Radially outwardly extending blades 84 are located at two diametrically opposed sides of the hollow cylindrical body, which engage into grooves 88 of housing 64 and form the rotation lock of spindle nut 80. Grooves 88 in housing 64 are formed as longitudinal grooves.

A width of blades 84 of spindle nut 80 in the circumferential direction is slightly less than a groove width of housing 64 formed in the circumferential direction. A length of blades 84 in the axial direction is considerably less than a length of grooves 88 of housing 64. Due to a rotation of spindle 68, spindle nut 80 is held by rotation lock 84, 88, so that spindle nut 80, including blades 84, is movable in the axial direction in housing 64 in the range across the length of grooves 88 of housing 64.

A hydraulic piston 92 is situated at spindle nut 80, which is connected to spindle nut 80. In contrast to spindle nut 80, hydraulic piston 92 is not in engagement with thread 76 of spindle 68. Hydraulic piston 92 is designed essentially in the shape of a cup. A seal 96 is situated between hydraulic piston 92 and hydraulic cylinder 66 of housing 64, so that a pressure is generatable in a working chamber 98 of hydraulic cylinder 66. Due to the rotation of spindle 68, hydraulic piston 92 may be axially displaced, via spindle nut 80, in the direction of working chamber 98, so that a brake fluid present in working chamber 98 may be pressurized.

1-10. (canceled)

11. An electromechanically driveable brake pressure generator for a hydraulic braking system of a vehicle, comprising:
at least one threaded drive assembly configured to convert a drive-side rotation into a translation; and
a piston/cylinder unit actuatable by the threaded drive assembly for hydraulic brake pressure generation;
wherein the threaded drive assembly includes:
a spindle which is rotatable via an electric motor,
a spindle nut which is situated on a thread of the spindle in such a way that, upon rotation of the spindle, the spindle nut and a hydraulic piston of the piston/cylinder unit formed thereon nut are axially displaceable,
a housing which forms a hydraulic cylinder of the piston/cylinder unit corresponding to the hydraulic piston in which the spindle and the spindle nut are accommodated, and
a rotation lock via which the spindle nut is secured against rotation upon rotation of the spindle.

12. The electromechanical brake pressure generator as recited in claim 11, wherein the spindle nut and the hydraulic piston are made of different materials and are situated lying coaxially next to one another.

13. The electromechanical brake pressure generator as recited in claim 11, wherein the rotation lock is formed by the housing and the hydraulic piston and/or the spindle nut.

14. The electromechanical brake pressure generator as recited in claim 11, wherein the rotation lock is formed by a tongue and groove connection.

15. The electromechanical brake pressure generator as recited in claim 11, wherein the rotation lock of the spindle nut forms two diametrically opposed, radially outwardly extending blades, which engage into corresponding grooves of the housing.

16. The electromechanical brake pressure generator as recited in claim 11, wherein at least a portion of the spindle nut is made of plastic.

17. The electromechanical brake pressure generator as recited in claim 16, wherein the portion of the spindle nut made of plastic is a plastic injection-molded part.

18. The electromechanical brake pressure generator as recited in claim 11, wherein the housing is made of an aluminum or steel alloy.

19. The electromechanical brake pressure generator as recited in claim 11, wherein at least the rotation lock at the spindle nut and/or the hydraulic piston is made of plastic to improve slide properties with respect to the housing made of metal.

20. A vehicle, comprising:
an electromechanical brake pressure generator for a hydraulic braking system, the electromechanical brake pressure generator including:
at least one threaded drive assembly configured to convert a drive-side rotation into a translation; and
a piston/cylinder unit actuatable by the threaded drive assembly for hydraulic brake pressure generation;
wherein the threaded drive assembly includes:
a spindle which is rotatable via an electric motor,
a spindle nut which is situated on a thread of the spindle in such a way that, upon rotation of the spindle, the spindle nut and a hydraulic piston of the piston/cylinder unit formed thereon nut are axially displaceable,
a housing which forms a hydraulic cylinder of the piston/cylinder unit corresponding to the hydraulic piston in which the spindle and the spindle nut are accommodated, and
a rotation lock via which the spindle nut is secured against rotation upon rotation of the spindle.
